(19) United States
(12) Patent Application Publication
(10) Pub. No.: US 2025/0319534 A1
(43) Pub. Date: Oct. 16, 2025

(54) RECIPROCATING SAW

(71) Applicant: MILWAUKEE ELECTRIC TOOL CORPORATION, Brookfield, WI (US)

(72) Inventors: Nathan D. Hankins, Caledonia, WI (US); Benjamin J. Farley, Milwaukee, WI (US); Michael J. Duenk, Waukesha, WI (US)

(21) Appl. No.: 19/175,041

(22) Filed: Apr. 10, 2025

Related U.S. Application Data
(60) Provisional application No. 63/633,242, filed on Apr. 12, 2024.
(60) Provisional application No. 63/654,234, filed on May 31, 2024.

(51) Int. Cl. B23D 51/10; B23D 49/16

(52) U.S. Cl. CPC B23D 51/10; B23D 49/16

(57) ABSTRACT

A blade clamp assembly including: a cover coupled to a sawbar to at least partially define, in tandem with the sawbar, a blade slot for receiving a saw blade, the cover including a detent slot; a detent positioned and movable in the detent slot, the detent configured to selectively engage the saw blade when positioned within the blade slot; and an actuator at least partially positioned between the cover and the sawbar, the actuator including a tapered surface engageable with the detent to move the detent within the detent slot; wherein the actuator is movable between a first position, in which the tapered surface and a surface of the detent slot wedge the detent against the saw blade to impart a clamping force to the saw blade, and a second position, in which the tapered surface permits the detent to disengage the saw blade and release the clamping force.

### CROSS-REFERENCE TO RELATED APPLICATIONS

This application claims priority to U.S. Provisional Patent Application No. 63/654,234 filed on May 31, 2024, and U.S. Provisional Patent Application No. 63/633,242 filed on Apr. 12, 2024, the entire contents of each of which are incorporated herein by reference.

### FIELD OF THE INVENTION

The present invention relates to power tools, and more particularly to reciprocating saws.

### BACKGROUND OF THE INVENTION

Reciprocating saws typically include an electric motor, a blade coupled to a scotch yoke mechanism, and a transmission for transferring torque from the motor to the scotch yoke mechanism, which converts the rotational input from the transmission to a reciprocating output of the blade. Such reciprocating saws are not typically utilized to provide precise cutting operations to a workpiece. However, this becomes challenging as the size and the weight of the saw increases.

### SUMMARY OF THE INVENTION

In some aspects, the techniques described herein relate to a blade clamp assembly including: a sawbar configured to reciprocate along a reciprocating axis; a saw blade configured to reciprocate with the sawbar along the reciprocating axis; a cover coupled to the sawbar to at least partially define, in tandem with the sawbar, a blade slot in which the saw blade is receivable, the cover including a detent slot in facing relationship with the sawbar; a detent positioned and movable in the detent slot, the detent configured to selectively engage the saw blade when positioned within the blade slot; and an actuator at least partially positioned between the cover and the sawbar, the actuator including a tapered surface engageable with the detent to move the detent within the detent slot; wherein the actuator is movable in a direction perpendicular to the reciprocating axis between a first position, in which the tapered surface and a surface of the detent slot wedge the detent against the saw blade to impart a clamping force to the saw blade and secure the saw blade within the blade slot, and a second position, in which the tapered surface permits the detent to disengage the saw blade and release the clamping force.

In some aspects, the techniques described herein relate to a blade clamp assembly including: a sawbar configured to reciprocate along a reciprocating axis; a saw blade configured to reciprocate with the sawbar along the reciprocating axis; a cover coupled to the sawbar to at least partially define, in tandem with the sawbar, a blade slot in which the saw blade is receivable, the cover including a detent slot in facing relationship with the sawbar, the detent slot positioned along a detent slot axis that is oriented at a non-parallel angle relative to the reciprocating axis; a detent positioned and movable in the detent slot, the detent configured to selectively engage the saw blade when positioned within the blade slot; and an actuator at least partially positioned between the cover and the sawbar, the actuator including a tapered surface engageable with the detent to move the detent within the detent slot; wherein the actuator is movable in a direction perpendicular to the reciprocating axis between a first position, in which the detent is wedged against the saw blade to impart a clamping force to the saw blade to secure the saw blade within the blade slot, and a second position, in which the detent is positioned to disengage the saw blade and release the clamping force, and wherein moving the actuator between the first position and the second position moves the detent within the detent slot along the detent slot axis.

In some aspects, the techniques described herein relate to a blade clamp assembly including: a sawbar configured to reciprocate along a reciprocating axis; a saw blade configured to reciprocate with the sawbar along the reciprocating axis; a cover coupled to the sawbar to at least partially define, in tandem with the sawbar, a blade slot in which the saw blade is receivable, the cover including a detent slot in facing relationship with the sawbar, the detent slot having a first end and a second end opposite the first end, the first end being positioned closer to the blade slot than the second end; a detent positioned and movable in the detent slot, the detent configured to selectively engage the saw blade when positioned within the blade slot; and an actuator at least partially positioned between the cover and the sawbar, the actuator including a tapered surface engageable with the detent to move the detent within the detent slot; wherein the actuator is movable in a direction perpendicular to the reciprocating axis between a first position, in which the detent is positioned adjacent to the first end of the detent slot and is wedged against the saw blade to impart a clamping force to the saw blade to secure the saw blade within the blade slot, and a second position, in which the detent is spaced apart from the first end of the detent slot and positioned to disengage the saw blade and release the clamping force.

In some aspects, the techniques described herein relate to a blade clamp assembly for use with a reciprocating saw, the blade clamp assembly including: a sawbar configured to reciprocate along a reciprocating axis, the sawbar including: a blade slot in which a saw blade is received, a V-shaped aperture extending therethrough and in communication with the blade slot, the V-shaped aperture including a first leg extending away from the reciprocating axis at an oblique angle relative to the reciprocating axis and a second leg extending away from the reciprocating axis at an oblique angle relative to the reciprocating axis, and a first engagement interface extending at least partially along a length of the sawbar; a collar rotatably coupled to the sawbar and including: an outer wall, an inner wall including a second engagement interface that is complementary to and engaged with the first engagement interface, and a circumferential groove defined in the inner wall; a first pin movably positioned within the first leg of the V-shaped aperture and having an end received in the circumferential groove; and a second pin movably positioned within the second leg of the V-shaped aperture and having an end received in the circumferential groove, wherein the collar is rotatable between a first position, in which the first pin and the second pin are wedged against the saw blade when positioned within the blade slot to impart a clamping force to the saw blade and secure the saw blade within the blade slot, and a second position, in which the first pin and the second pin are disengaged from the saw blade to release the clamping force; and wherein as the collar rotates from the first position to the second position, the end of each of the first pin and the second pin moves within the circumferential groove such that each of the first pin and the second pin move away from the reciprocating axis along the first leg and the second leg, respectively.

Other aspects of the application will become apparent by consideration of the detailed description and accompanying drawings.

### BRIEF DESCRIPTION OF THE DRAWINGS

FIG. 1 is a side view of a reciprocating saw in accordance with an embodiment of the invention.

FIG. 2 is a perspective view of a blade clamp assembly for use with the reciprocating saw of FIG. 1.

FIG. 3 is another perspective view of the blade clamp assembly of FIG. 2.

FIG. 4 is a cross-sectional view of the blade clamp assembly of FIG. 2 and showing an actuator in a first position.

FIG. 5 is a cross-sectional view of the blade clamp assembly of FIG. 2 and showing the actuator in a second position.

FIG. 6 is a perspective view of a blade clamp assembly for use with the reciprocating saw of FIG. 1.

FIG. 7 is a perspective view of the blade clamp assembly of FIG. 6 and showing an actuator in a first position.

FIG. 8 is a perspective view of the blade clamp assembly of FIG. 6 and showing the actuator in a second position.

FIG. 9A is a perspective view of a blade clamp assembly for use with the reciprocating saw of FIG. 1.

FIG. 9B is a top view of the blade clamp assembly of FIG. 9A.

FIG. 10A is a perspective view of the blade clamp assembly of FIG. 9A and showing an actuator in a first position.

FIG. 10B is a perspective view of the blade clamp assembly of FIG. 9A and showing the actuator in a second position.

FIG. 11A is a perspective view of a blade clamp assembly for use with the reciprocating saw of FIG. 1.

FIG. 11B is a partially exploded view of the blade clamp assembly of FIG. 11A.

FIG. 11C is a perspective view of the blade clamp assembly of FIG. 11A and showing an actuator in a first position.

FIG. 11D is a perspective view of the blade clamp assembly of FIG. 11A and showing the actuator in a second position.

FIG. 11E is a cross-sectional view of the blade clamp assembly of FIG. 11A showing the actuator in the first position.

FIG. 11F is a cross-sectional view of the blade clamp assembly of FIG. 11A showing the actuator in the second position.

FIG. 12 is a perspective view of a blade clamp assembly for use with the reciprocating saw of FIG. 1.

FIG. 13 is a perspective view of the blade clamp assembly of FIG. 12 and showing an actuator in a first position.

FIG. 14 is a perspective view of the blade clamp assembly of FIG. 12 and showing the actuator in a second position.

FIG. 15 is a perspective view of a blade clamp assembly for use with the reciprocating saw of FIG. 1.

FIG. 16 is a detailed perspective view of the blade clamp assembly of FIG. 15 in a first position.

FIG. 17 is a cross-sectional view of the blade clamp assembly of the FIG. 15 in the first position.

FIG. 18 is a schematic view of the blade clamp assembly of FIG. 15 in the first position.

FIG. 19 is a perspective view of the blade clamp assembly of FIG. 15 in a second position.

FIG. 20 is a schematic view of the blade clamp assembly of FIG. 15 in the second position.

FIG. 21 is a perspective view of a blade clamp assembly for use with the reciprocating saw of FIG. 1.

FIG. 22 is a detailed perspective view of the blade clamp assembly of FIG. 21.

FIG. 23 is another perspective view of the blade clamp assembly of the FIG. 21 in an assembly position.

FIG. 24 is a perspective view of the blade clamp assembly of FIG. 24 in a first position.

FIG. 25 is a schematic view of the blade clamp assembly of FIG. 21 in a second position.

FIG. 26 is a top view of the blade clamp assembly of FIG. 21 with a portion removed.

FIG. 27 is a side cross-sectional view of a portion of the blade clamp assembly of FIG. 21.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

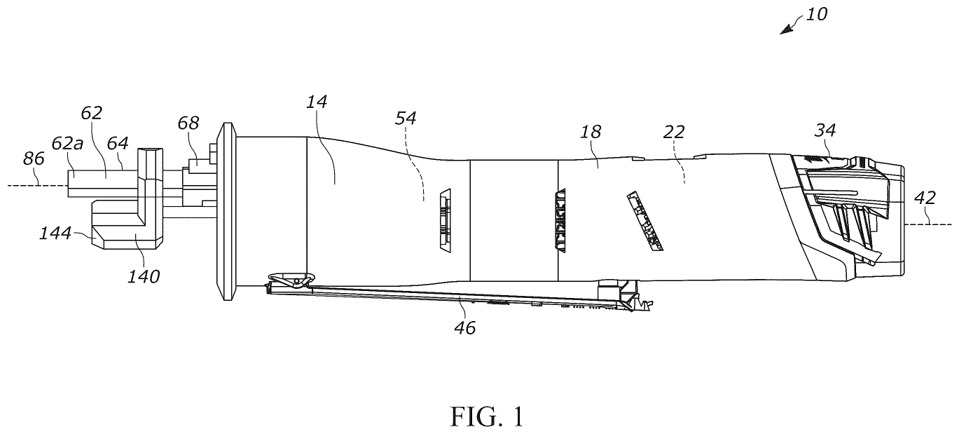

FIG. 1 illustrates a power tool, configured as a compact reciprocating saw 10, embodying the invention. The reciprocating saw 10 includes a housing 14, defining a motor housing portion 18, and an electric motor 22 (shown schematically) positioned in the motor housing portion 18. The motor 22 includes a motor output shaft defining a rotational axis. The saw 10 also includes a battery pack 34 at least partially received in a battery receptacle 38 in the housing 14 along an insertion axis 42 that is parallel with the rotational axis. Alternatively, the insertion axis 42 may be parallel with the rotational axis. The saw 10 further includes a motor activation trigger 46 pivotably coupled to the housing 14 and graspable by a user of the reciprocating saw 10 between a first position, in which the motor 22 is deactivated, and a second position, in which is motor 22 is activated.

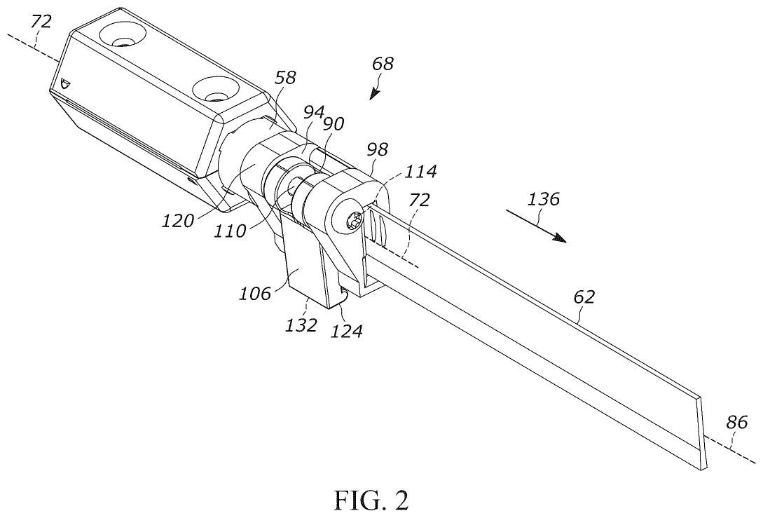

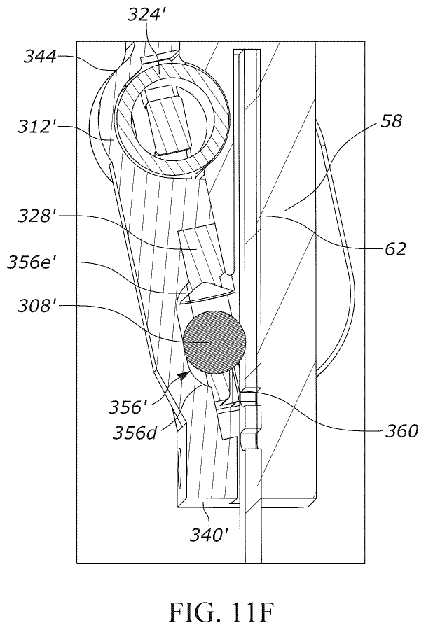

With further reference to FIG. 1, the saw 10 also includes a transmission 54 (shown schematically) positioned downstream of the motor 22 in the motor housing portion 18. The transmission 54 includes a yoke or spindle (not shown), which hereinafter will be referred to as a sawbar 58 (FIGS. 2-20), connectable to a saw blade 62 having a serrated edge 64 that contacts with a workpiece. In the illustrated embodiments, the saw 10 includes a blade clamp assembly 68 on the sawbar 58 to quickly attach and release the saw blade 62 to the sawbar 58. The sawbar 58 defines a longitudinal axis 72, which is parallel to the rotation axis and the insertion axis 42. The transmission 54 converts a rotational input provided by the motor output shaft to a reciprocating output of the sawbar 58 along a reciprocating axis 86 that is parallel with the rotational axis of the motor output shaft.

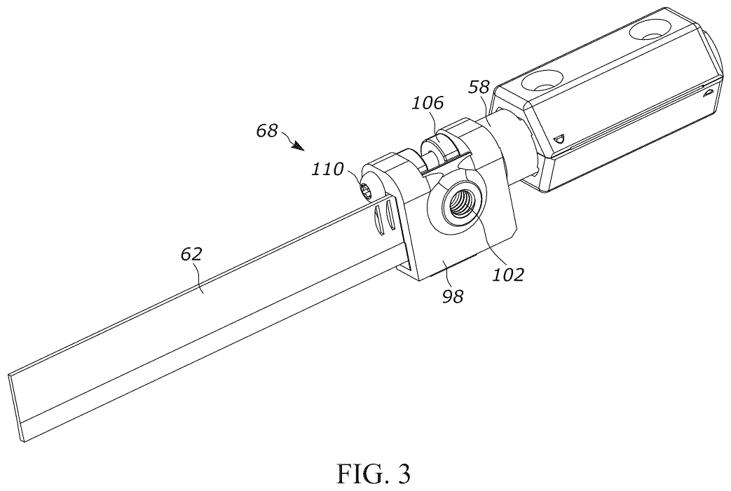

In the embodiment of FIGS. 2-5, the sawbar 58 includes a first wall 90, a second wall 94 adjacent to the first wall 90, and a third wall 98 opposite the first wall 90. When coupled to the sawbar 58, the saw blade 62 abuts the first wall 90 and the second wall 94. An aperture 102 (FIG. 3) extends between the first wall 90 and the third wall 98. The aperture 102 is configured to receive a fastener (not shown).

The blade clamp assembly 68 includes an actuator 106 and fastener 110. The actuator 106 is a lever that is pivotably coupled to the sawbar 58 by the fastener 110. The fastener 110 is coupled to the sawbar 58 along an axis 114 that is parallel to the longitudinal axis 72 of the sawbar 58. The fastener 110 is spaced apart from the first wall 90. The actuator 106 includes a first end 120 and a second end 124 opposite the first end 120. The first end 120 includes a cam 128. The actuator 106 has an axis 132 that extends between the first end 120 and the second end 124. The fastener 110 extends through the first end 120, while the second end 124 is spaced apart from the fastener 110.

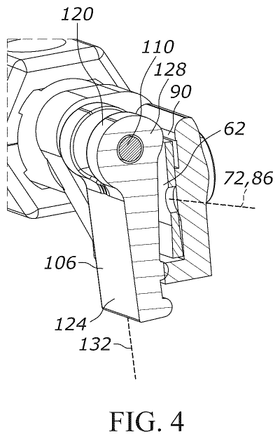

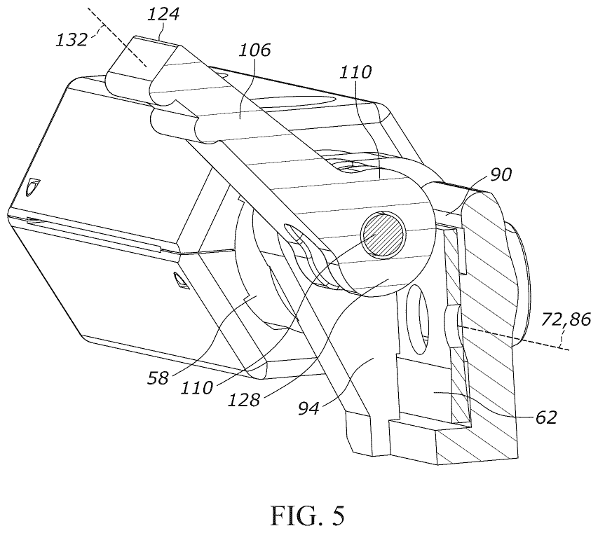

The actuator 106 is pivotal about the fastener 110 between a first position (FIG. 4) and a second position (FIG. 5). In the first position, the axis 132 of the actuator 106 is generally parallel to a plane extending along the longitudinal axis 72 and the cam 128 exerts a clamping force on the saw blade 62. Accordingly, in the first position, the saw blade 62 is clamped between the first wall 90 and the cam 128. In the second position, the axis 132 of the actuator 106 is at a non-parallel angle relative to the plane extending along the longitudinal axis 72 and the cam 128 is spaced apart from the saw blade 62 so that the clamping force is no longer on the saw blade 62. Accordingly, in the second position, the saw blade 62 is insertable and removable from the sawbar 58. When the saw blade 62 is clamped to the sawbar 58 and reciprocating, the cam 128 of the actuator 106 secures the saw blade 62 to the sawbar 58 when the saw blade 62 moves in a first (forward) direction (noted by arrow 136) and the saw blade 62 engages the second wall 94 when the saw blade 62 moves a second (rearward) direction (opposite the arrow 136).

The fastener (e.g., a setscrew) received in the aperture 102 exerts another clamping force on the saw blade 62. The fastener is configured as an additional clamp mechanism for clamping the blade 62 to the sawbar 58. In some embodiments, the saw blade 62 may clamp against the setscrew in the first position.

With reference to FIG. 1, the saw 10 also includes a shoe 140 extending from the housing 14 against which the saw blade 62 is supportable. The shoe 140 may be adjustable relative to the housing 14 to vary the distance D that a distal end 62a of the saw blade 62 protrudes from a distal end 144 of the shoe 140, to thereby vary the cutting depth of the saw blade 62.

Once the cutting depth distance D is set by the user of the saw 10 as described above, the saw 10 is ready for use. The user grips the motor housing portion 18 with the palm of their hand and wraps one or more fingers over the trigger 46. With the blade 62 positioned adjacent an edge of a workpiece, the user rests the distal end 144 of the shoe 140 against the workpiece and depresses the trigger 46, thereby activating the motor 22 to reciprocate the blade 62. Alternatively, the user may first activate the motor 22 by depressing the trigger 46, and then plunge the blade 62 into the workpiece without a pilot hole. As the saw 10 is pushed along a cut direction, a reaction force is applied to the blade 62 in an opposite direction. However, the shoe 140 supports the saw blade 62 and prevents it from deflecting, thereby maintaining a straight cutting edge, and permitting the blade 62 to be plunged into a workpiece without first creating a pilot hole. Alternatively, the saw blade 62 may be supported by a separate bracket other than the shoe 140.

The compact size of the reciprocating saw 10 allows for a more accurate and higher controlled cut. Furthermore, the compact size allows for an increased level of cut precision, residual debris management, and portability.

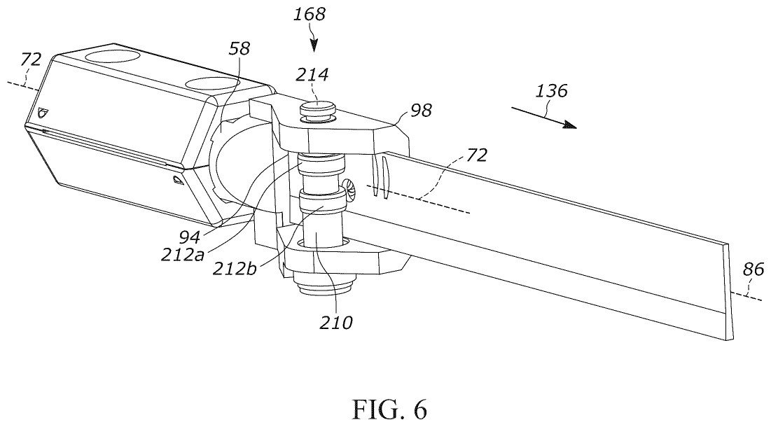

Another blade clamp assembly 168 for use with the reciprocating saw of FIG. 1 is shown in FIGS. 6-8. The blade clamp assembly 168 includes an actuator 206 and fastener 210. The actuator 206 is a lever that is pivotably coupled to the sawbar 58 by the fastener 210. The fastener 210 is coupled to the sawbar 58 along an axis 214 that is perpendicular to the longitudinal axis 72 of the sawbar 58. The fastener 210 is spaced apart from the first wall 90 of the sawbar 58. The fastener 210 includes a first cam 212a and a second cam 212b. In other embodiments, there may be a single cam or more than two cams. The actuator 206 includes a first end 220 and a second end 224 opposite the first end 220. The first end 220 of the actuator 206 is fixedly coupled to the fastener 210.

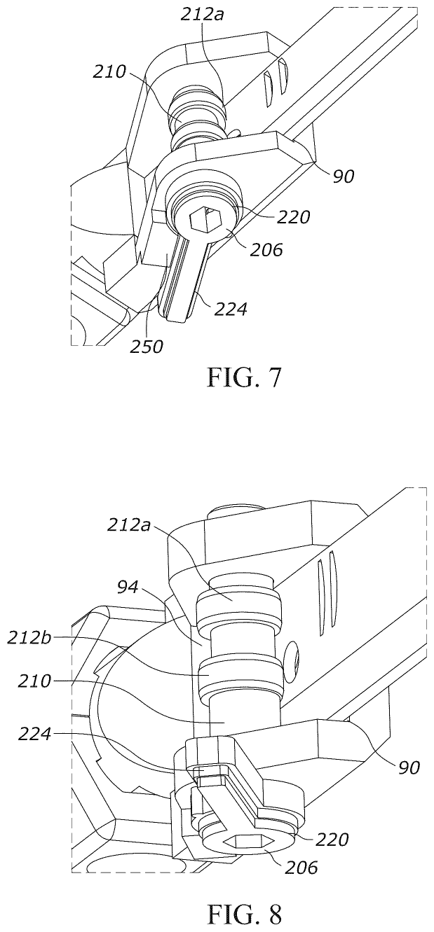

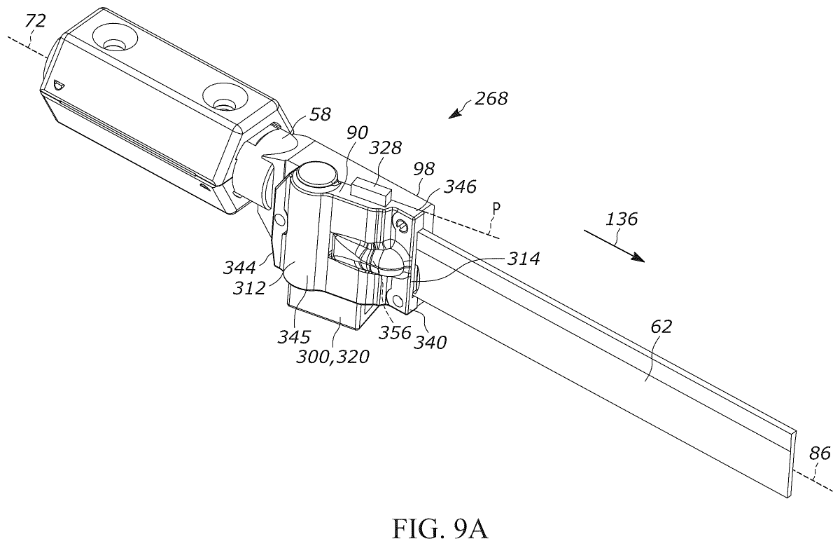

The actuator 206 pivots the fastener 210. The actuator 206 is pivotable between a first position (FIG. 7) and a second position (FIG. 8). In the first position, a portion of the actuator 206 abuts a stop 250 of the sawbar 58 and the first and second cams 212a, 212b exert a clamping force against the saw blade 62. Accordingly, in the first position, the saw blade 62 is clamped between the first wall 90 and the first and second cams 212a, 212b. In the second position, the actuator 206 is spaced apart from the stop 250 of the sawbar 58 and the first and second cams 212a, 212b are spaced apart from the saw blade 62 so that the clamping force is no longer on the saw blade 62. Accordingly, in the second position, the saw blade 62 is insertable and removable from the sawbar 58. When the saw blade 62 is clamped to the sawbar 58 and reciprocating, the first and second cams 212a, 212b of the actuator 206 secure the saw blade 62 to the sawbar 58 when the saw blade 62 moves in a first (forward) direction (noted by arrow 136) and the saw blade 62 engages the second wall 94 when the saw blade 62 moves a second (rearward) direction (opposite the arrow 136).

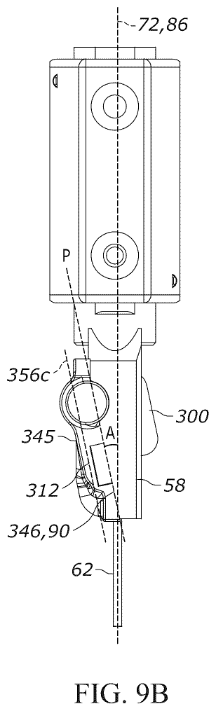

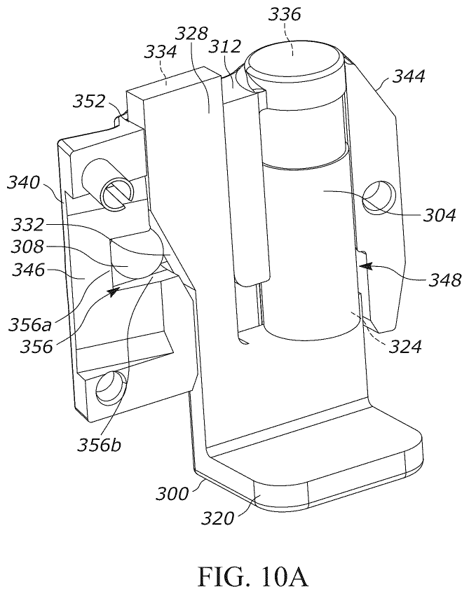

Another blade clamp assembly 268 is shown in FIGS. 9A-10B for use with the reciprocating saw 10 of FIG. 1. The blade clamp assembly 268 includes the sawbar 58, an actuator 300, a biasing member 304 (FIGS. 10A and 10B), a detent 308 (FIGS. 10A and 10B), and a cover 312. The cover 312 is coupled to the sawbar 58 to define, in tandem with the sawbar 58, a blade slot 314 in which the saw blade 62 is receivable. The actuator 300 includes a first end 320, a first arm 324 extending from the first end 320, and a second arm 328 extending from the first end 320. The first arm 324 is spaced apart from the second arm 328. The second arm 328 includes a tapered surface 332. The first end 320 of the actuator 300 is positioned on a bottom side of the sawbar 58, and the first arm 324 and the second arm 328 extend between the sawbar 58 (e.g., between the first wall 90 of the sawbar 58) and the cover 312 (e.g., the second side 346 of the cover 312). The first and second arms 324, 328 each extend along respective axes 334, 336 that are generally perpendicular to the longitudinal axis 72 of the sawbar 58. The second arm 328 is accessible from a top side of the sawbar 58.

The cover 312 includes a first end 340, a second end 344 opposite the first end 340, a first side 345, and a second side 346 opposite the first side 345, a bottom side, and a top side. The second side 346 of the cover 312 faces the first wall 90 of the sawbar 58. At least a portion of each of the second side 346 of the cover 312 and the first wall 90 are parallel to each other and parallel to a plane P, as shown in FIGS. 9A and 9B. The plane P intersects with the longitudinal axis 72 of the sawbar 58 and the reciprocation axis 86 at an angle A. In the illustrated embodiment, the angle A is 12 degrees, but may range from 5 degrees to 20 degrees in other embodiments. In the illustrated embodiment, as shown in FIG. 10A, the cover 312 includes a first recess 348 and a second recess 352 in an inner surface of the second side 346, each extending from the bottom side toward the top side. In the illustrated embodiment, the first arm 324 is positioned in and movable relative to the first recess 348 and the second arm 328 is positioned in and movable relative to the second recess 352 in the cover 312. The cover 312 also includes a slot 356 (e.g., a detent slot) in the inner surface of the second side 346. The slot 356 extends horizontally when the saw 10 is oriented parallel to the ground. The slot 356 extends along a slot axis 356c that is parallel to the plane P (FIG. 9B). The slot 356 has a closed end 356a positioned adjacent to the first end 340 and an open end 356b spaced apart from the closed end 356a. The open end 356b of the slot 356 is in communication with the second recess 352 of the cover 312. Due to the angle A between the plane P and the reciprocating axis 86, the closed end 356a of the slot 356 is generally closer to the reciprocating axis 86 (and therefore the blade slot 314) than the open end 356b of the slot 356. The detent 308 is a ball that is received in and movable relative to the slot 356.

The biasing member 304 (e.g., a compression spring or a coil spring) is positioned between the actuator 300 and the cover 312. The biasing member 304 is axially constrained by the actuator 300 and the cover 312. In the illustrated embodiment, the first arm 324 is positioned within the biasing member 304.

The actuator 300 is slidable between a first position (FIG. 10A) and a second position (FIG. 10B). The actuator 300 is biased into the first position by the biasing member 304. The actuator 300 is moved in the direction of arrow 358 (e.g., vertically and upwardly relative to the reciprocating axis 86) to move the actuator 300 from the first position to the second position against the bias of the biasing member 304. In the first position, the tapered surface 332 is positioned adjacent the open end 356b of the slot 356 to force the detent 308 against the closed end 356a of the slot 356. Because the closed end 356a of the slot 356 is positioned closer to the reciprocating axis 86, when the tapered surface 332 forces the detent 308 against the closed end 356a of the slot 356, the detent 308 exerts a clamping force against the saw blade 62. Accordingly, the tapered surface 332 and the slot 356 (e.g., a surface of the slot 356 at or adjacent to the closed end 356a thereof) wedge the detent 308 against the saw blade 62 to exert the clamping force against the saw blade 62. Accordingly, in the first position, the saw blade 62 is clamped between the first wall 90 and the detent 308. In the second position, the tapered surface 332 is spaced apart from open end 356b of the slot 356 such that the detent 308 is spaced apart from the closed end 356a of the slot 356. Therefore, the detent 308 is spaced apart from the saw blade 62 so that the clamping force is no longer on the saw blade 62. More specifically, moving the actuator 300 from the first position to the second position causes the tapered surface 332 to move in the direction of arrow 358 (upward and vertically relative to the reciprocation axis 86). The upward vertical movement of the actuator 300 causes the detent 308 to move horizontally within the slot 356, generally parallel to the plane P, and away from the reciprocating axis 86 (and the saw blade 62). Accordingly, in the second position, the saw blade 62 is insertable and removable from the sawbar 58.

In summary, the actuator 300 moves vertically between the first and second positions (i.e., when the reciprocating axis 86 is oriented parallel with the ground), which corresponds to horizontal movement of the detent 308 relative to the reciprocating axis 86 (and therefore the saw blade 62) at the angle A. When the saw blade 62 is clamped to the sawbar 58 and reciprocating, the detent 308 secures the saw blade 62 to the sawbar 58 when the saw blade 62 moves in a first (forward) direction (noted by arrow 136) and the saw blade 62 engages the second wall 94 (not shown in FIGS. 9A-10B) when the saw blade 62 moves a second (rearward) direction (opposite the arrow 136).

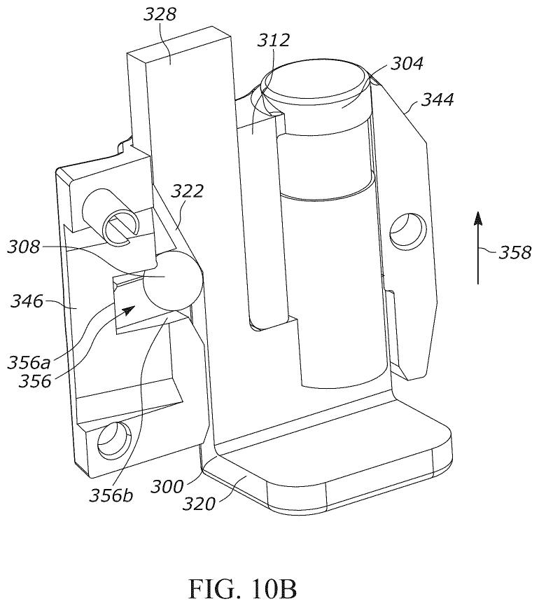

Another blade clamp assembly 268′ is shown in FIGS. 11A-11F for use with the reciprocating saw 10 of FIG. 1. The blade clamp assembly 268′ is similar to the blade clamp assembly 268 of FIGS. 9A-10B. Therefore, like reference structure will be indicated with like reference numerals with a prime (′) and only the differences discussed herein. The blade clamp assembly 268′ includes the sawbar 58, an actuator 300′, a biasing member 304′, a detent 308′, and a cover 312′. The cover 312′ is coupled to the sawbar 58 to define, in tandem with the sawbar 58, a blade slot 314′ in which the saw blade 62 is receivable. The second arm 328′ includes a Z-shaped slot 360 that defines the tapered surface 332′. The tapered surface 332′ is a first tapered surface 332′ and the Z-shaped slot 360 further includes a second tapered surface 333, which is parallel to the first tapered surface 332′. The Z-shaped slot 360 includes a first end 360a positioned adjacent to the first end 320′ of the actuator 300′ and a second end 360b opposite the first end 360a. The tapered surfaces 332′, 333 are positioned between the first end 360a and the second end 360b. The detent 308′ is received and movable within the Z-shaped slot 360. The Z-shaped slot 360 limits the horizontal and vertical movement of the detent 308′.

The cover 312′ includes a recess 354 in the second side 346′. The recess 354 receives the first and second arms 324′, 328′ of the actuator 300′. The horizontal slot 356′ (e.g., the detent slot) includes a first end 356d and a second end 356c. The first end 356d of the slot 356′ is positioned closer to the first end 340 of the cover 312′ than the second end 356e of the slot 356′. Due to the angle A between the plane P and the reciprocating axis 86 (FIG. 11E), the first end 356d of the horizontal slot 356′ is generally closer to the reciprocating axis 86 than the second end 356e of the horizontal slot 356′. In addition to the recess 354 and the horizontal slot 356′, the cover 312′ further includes a first projection 351a and a second projections 351b extending from the second side 346′. The first projection 351a is positioned below the slot 356′ and the second projection 351b is positioned above the slot 356′. As shown, the Z-shaped slot 360 overlaps and is in communication with the horizontal slot 356′. That is, the first end 360a is positioned on one side of the horizontal slot 356′, while the second end 360b is positioned on the opposite side of the horizontal slot 356′. The first and second projections 351a, 351b are positioned within the Z-shaped slot 360 and act as stop surfaces for the actuator 300′, as will be discussed below.

The actuator 300′ is slidable between a first position (FIGS. 11C and 11E) and a second position (FIGS. 11D and 11F). The actuator 300′ is biased into the first position by the biasing member 304′. The actuator 300′ is moved in the direction of arrow 358′ (e.g., vertically and upwardly relative to the reciprocation axis 86) to move the actuator 300′ from the first position to the second position against the bias of the biasing member 304′. In the first position, the tapered surface 332′ is positioned adjacent the second end 356e of the slot 356′ to force the detent 308′ towards the first end 356d of the slot 356′. Additionally, the second projection 361b abuts the second end 360b of the Z-shaped slot 360. Because the first end 356d of the slot 356′ is positioned closer to the reciprocating axis 86, when the tapered surface 332′ forces the detent 308′ against the first end 356d of the slot 356′, the detent 308′ exerts a clamping force against the saw blade 62. As shown, the tapered surface 332′ and the slot 356′ (e.g., a surface of the slot 356′ at or adjacent to the closed end 356d thereof) wedge the detent 308′ against the saw blade 62 to exert the clamping force against the saw blade 62. Accordingly, in the first position, the saw blade 62 is clamped between the first wall 90 and the detent 308′. In the second position, the tapered surface 332′ is spaced apart from second end 356e of the slot 356′ such that the detent 308′ is spaced apart from the first end 356d of the slot 356′. The second tapered surface 333 forces the detent 308′ against the second end 356e. The detent 308′ is therefore spaced apart from the saw blade 62 so that the clamping force is no longer on the saw blade 62. Additionally, the first projection 361a abuts the first end 360a of the Z-shaped slot 360. More specifically, moving the actuator 300′ from the first position to the second position causes the tapered surface 332′ to move in the direction of arrow 358′ (vertically and upwardly relative to the reciprocation axis 86). The upward vertical movement of the actuator 300′ causes the detent 308′ to move horizontally within the slot 356′, generally parallel to the plane P, and away from the reciprocating axis 86. Accordingly, in the second position, the saw blade 62 is insertable and removable from the sawbar 58.

Similar to FIGS. 9A-10B, the actuator 300′ moves vertically, which corresponds to horizontal movement of the detent 308′ (i.e., when the reciprocating axis 86 is oriented parallel with the ground) relative to the reciprocating axis 86 (and therefore the saw blade 62) at the angle A. When the saw blade 62 is clamped to the sawbar 58 and reciprocating, the detent 308′ secures the saw blade 62 to the sawbar 58 when the saw blade 62 moves in a first (forward) direction (noted by arrow 136) and the saw blade 62 engages the second wall 94 (not shown in FIGS. 11A-11F) when the saw blade 62 moves a second (rearward) direction (opposite the arrow 136).

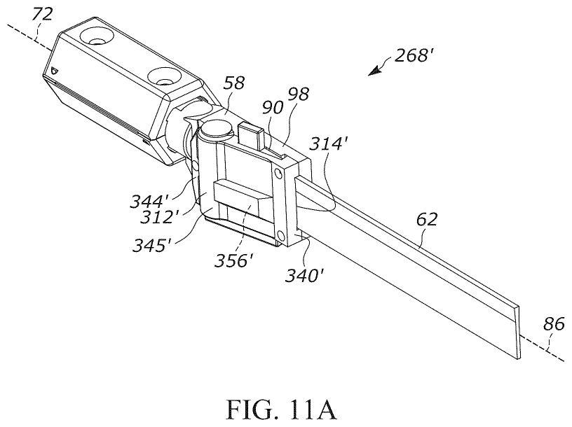

Another blade clamp assembly 368 is shown in FIGS. 12-14 for use with the reciprocating saw 10 of FIG. 1. The blade clamp assembly 368 includes an actuator 400, a pair of intermediate members 404a, 404b, a pair of springs 408a, 408b, and a fastener 412. The actuator 400 is a U-shaped member including a central portion 416 defining a first end, a first leg 420a extending from the central portion 416 toward a second end, and a second leg 420b extend from the central portion 416 towards the second end. The central portion 416 is positioned on a first side of the sawbar 58. The first leg 420a extends across a top surface of the sawbar 58. The second leg 420b extends across a bottom surface of the sawbar 58. Each of the first leg 420a and the second leg 420b defines an arcuate slot 424a, 424b (only the arcuate slot 424b in the second leg 420b is shown).

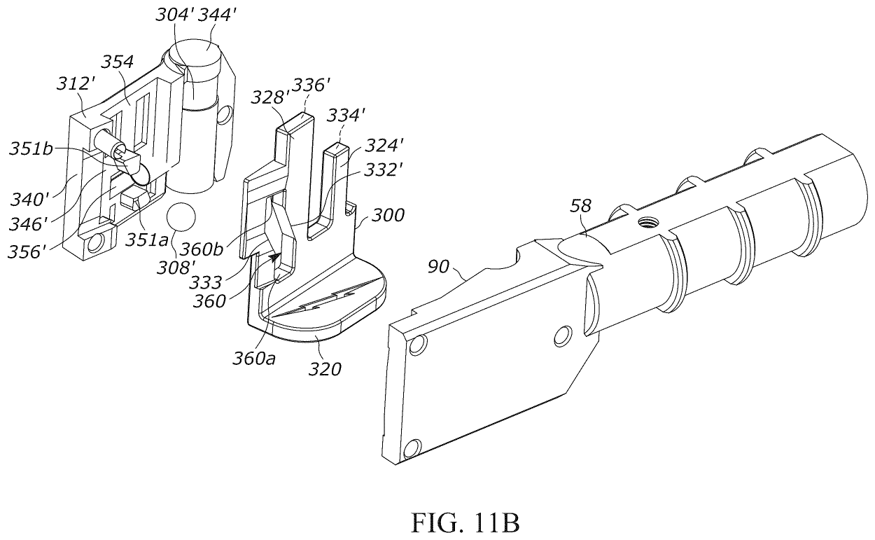

One of the intermediate members 404a is positioned between the sawbar 58 and the first leg 420a, and the other of the intermediate members 404b (FIG. 13) is positioned the sawbar 58 and the second leg 420b. Each of the intermediate members 404a, 404b includes a first end and a second end, opposite the first end, with a post 428a, 428b (only the post 428b of the intermediate member 404b is shown in FIGS. 12 and 13) that is received and movable within the arcuate slot 424a, 424b of the respective first and second leg 420a, 420b. One of the springs 408a extends between the actuator 400 and one of the intermediate members 404a, and the other of the springs 408b (FIG. 13) extends between the actuator 400 and the other of the intermediate members 404b. The fastener 412 is coupled between the first and second intermediate members 404a, 404b. The fastener 412 extends through and is movable relative to a pair of slots 432a, 432b of a sawbar 58. The slots 432a, 432b are oriented along axes 436a, 436b that are at a non-parallel angle relative to the longitudinal axis 72 of the sawbar 58.

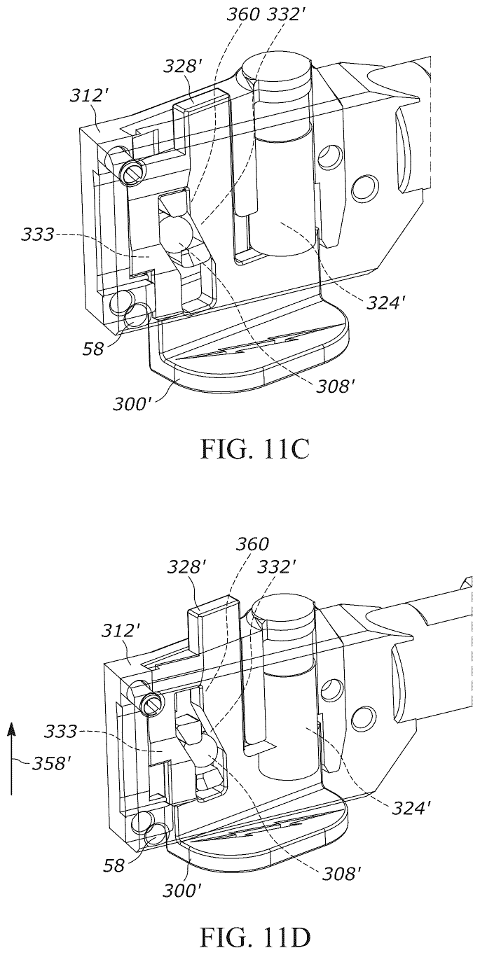

The actuator 400 is movable between a first position (FIGS. 12 and 13) and a second position (FIG. 14). The actuator 400 is biased into the first position by the springs 408a, 408b. As shown in FIG. 14, the actuator 400 is pivotable in the direction of arrow 440 from the first position to the second position. In the first position, the posts 428a, 428b of the intermediate members 404a, 404b are positioned against a first end of the slots 424a, 424b in the first and second legs 420a, 420b of the actuator 400. In the first position, the fastener 412 is forced against a first end of the slots 432a, 432b in the sawbar 58. When the actuator 400 is positioned against the first end of the slots 432a, 432b of the sawbar 58, a cam 444 of the fastener 412 exerts a clamping force on the saw blade 62. Accordingly, in the first position, the saw blade 62 is clamped between the cam 444 of the fastener 412 and first wall 90 of the sawbar 58. In the second position, the posts 428a, 428b of the intermediate members 404a, 404b are positioned against a second end of the slots 424a, 424b in the first and second legs 420a, 420b of the actuator 400 and the fastener 412 is spaced apart from the first ends of the slots 432a, 432b of the sawbar 58. When the fastener 412 is positioned against the second end of the slots 424a, 424b of the first and second legs 420a, 420b, the cam 444 of the fastener 412 is spaced apart from the saw blade 62 so the cam 444 no longer exerts a clamping force against the saw blade 62. Accordingly, in the second position, the saw blade 62 is insertable and removable from the sawbar 58. Pivoting the actuator 400 in the direction arrow 440 from the first position to the second position moves the posts 428a, 428b along the arcuate slots 424a, 424b in the legs 420a, 420b from the first end to the second end. Moving the posts 428a, 428b causes movement of the intermediate members 404a, 404b and the fastener 412 relative to the sawbar 58 to move the cam 444 away from the saw blade 62. When the saw blade 62 is clamped to the sawbar 58 and reciprocating, the cam 444 of the fastener 412 secures the saw blade 62 to the sawbar 58 when the saw blade 62 moves in a first (forward) direction (noted by arrow 136) and the saw blade 62 engages the second wall 94 (not shown in FIGS. 12-14) when the saw blade 62 moves a second (rearward) direction (opposite the arrow 136).

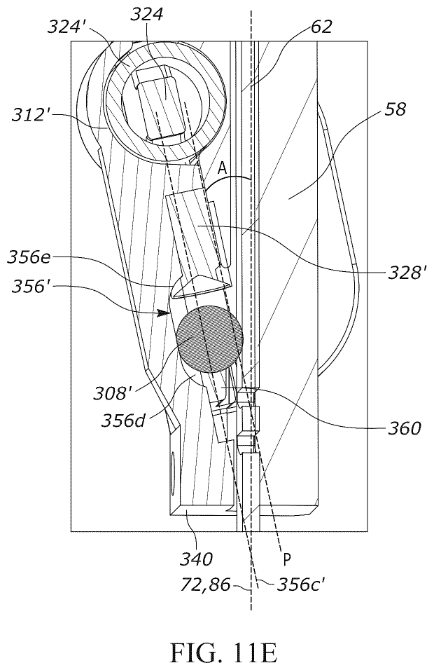

Another blade clamp assembly 468 is shown in FIGS. 15-20 for use with the reciprocating saw 10 of FIG. 1.

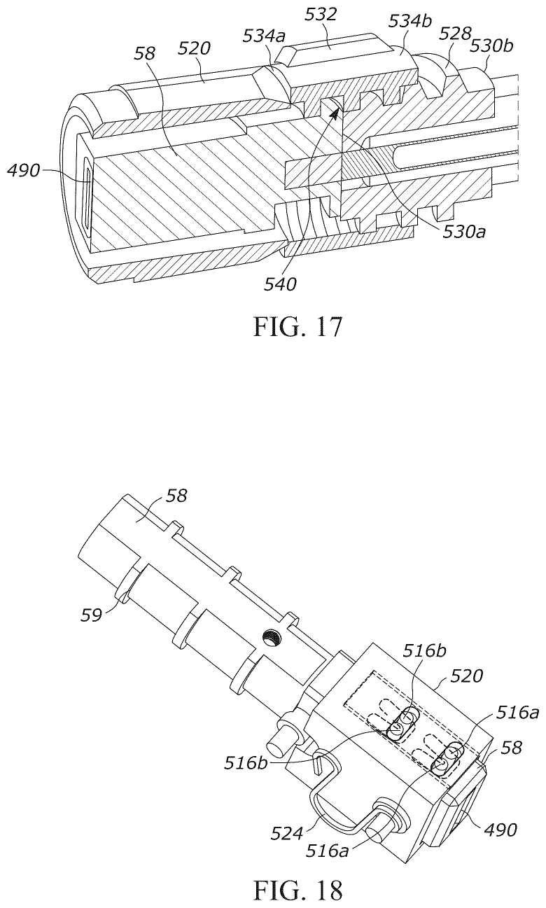

In the embodiment of FIGS. 15-20, the sawbar 58 defines a slot 490 that receives the saw blade 62 (not shown in FIGS. 15-20). With respect to the schematic view of FIG. 20, the sawbar 58 also includes a first V-shaped aperture 500a and a second V-shaped aperture 500b in each of the top side and the bottom side (only the V-shaped apertures 500a, 500b are shown in FIG. 20). The first V-shaped aperture 500a in the top side is aligned with the first V-shaped aperture 500a in the bottom side and the second V-shaped aperture 500b in the top side is aligned with the second V-shaped aperture 500b in the bottom side. Each of the V-shaped apertures 500a, 500b are in communication with the slot 490. Each of the V-shaped apertures 500a, 500b includes a central portion 504a, 504b and a pair of legs 508a, 508b extending at a non-perpendicular (i.e., an oblique) angle from the central portion 504a, 504b. A pair of pins or rollers 516a, 516a extends through the aligned first V-shaped apertures 500a and a pair of pins 516a, 516a extends through the aligned second V-shaped apertures 500b. Each of the pins 516a, 516b has a first end extending from the top side of the sawbar 58 and a second end that extends from the bottom side of the sawbar 58. In other embodiments, the central portion 504a, 504b may be omitted such that the pairs of legs 508a, 508b are not connected to one another.

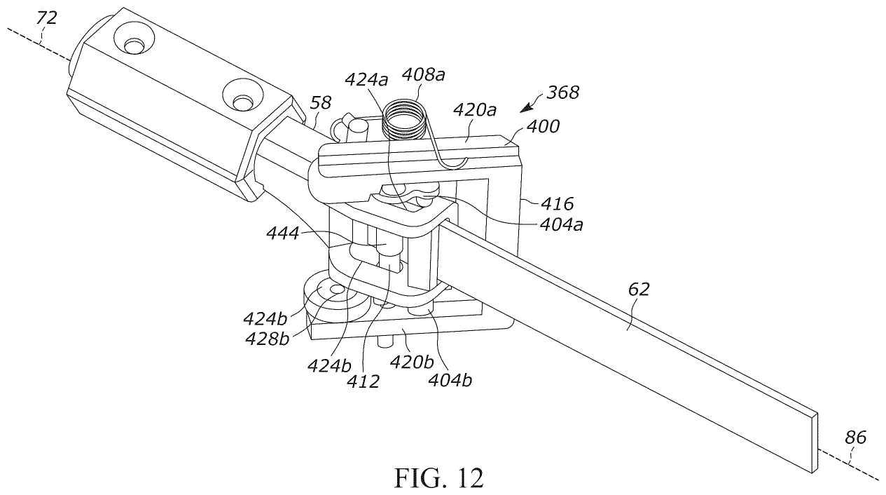

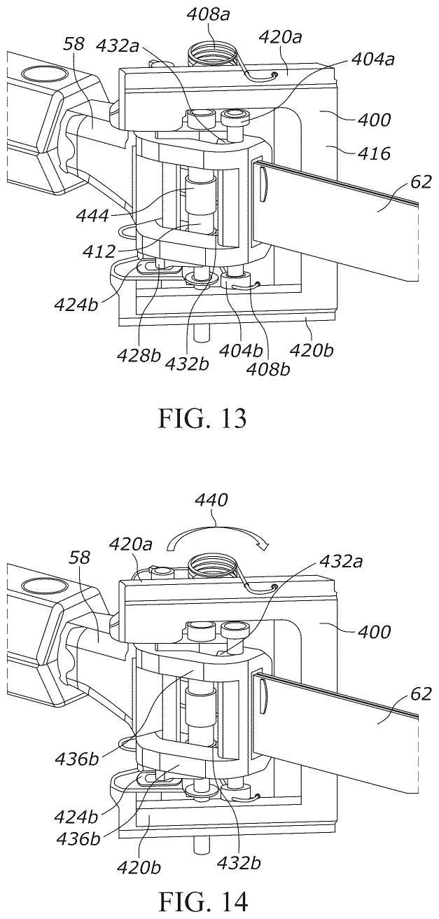

The blade clamp assembly 468 includes the sawbar 58, the pins 516a, 516b, a first collar 520, a spring 524 (FIGS. 18 and 20), a second collar 528, and nut 532. The first collar 520 surrounds and is axially slideable relative to the sawbar 58. Each of the first end and the second end of the pins 516a, 516b are received in and movable relative to slots 536a, 536b (FIG. 20) in the first collar 520. The spring 524 extends between the sawbar 58 and the first collar 520. The second collar 528 is fixed to the sawbar 58 and spaced apart from the first collar 520 by a gap 540 (FIG. 17). The second collar 528 includes a first end 530a and a second end 530b opposite the first end 530a. The second collar 528 has a threaded interface. The nut 532 has a threaded interface that engages the threaded interface of the second collar 528. The nut 532 has a first end 534a and a second end 534b opposite the first end 534a.

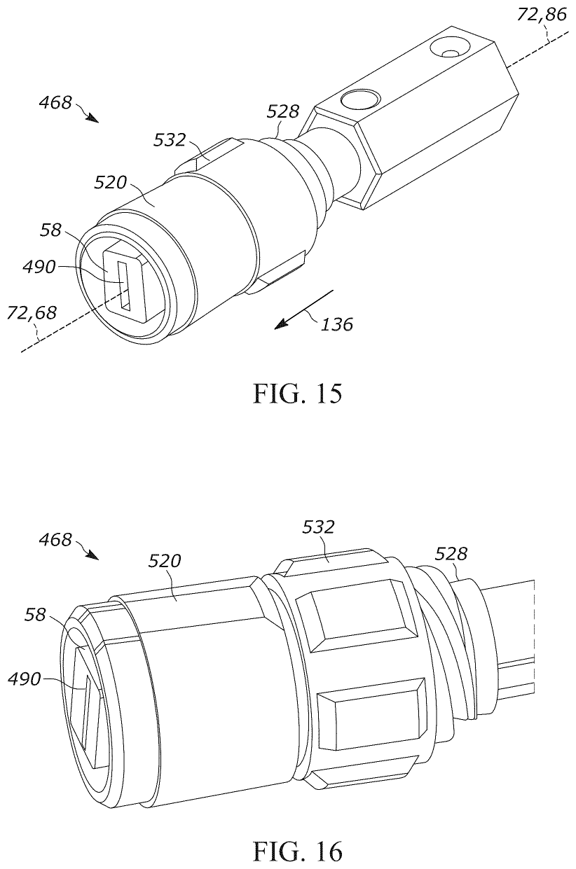

The nut 532 is movable between a first position (FIGS. 15-18) and a second position (FIGS. 19-20). In the first position, the first end 534a of the nut 532 abuts the first collar 520 and is spaced apart from the second end 530b of the second collar 528 such that the first end 534a of the nut 532 is at least partially positioned in the gap 540 between the first collar 520 and the second collar 528. In the first position, the second end 534b of the nut 532 is spaced apart from the second end 530b of the second collar 528. In the second position, the second end 534b of the nut 532 abuts (or is otherwise closer to) the second end 530b of the second collar 528. Accordingly, at least a portion of the gap 540 between the first collar 520 and the second collar 528 is unobstructed.

The first collar 520 is axially movable along the sawbar 58 between a first position (FIGS. 15-18) and a second position (FIGS. 19-20). When the first collar 520 is in the first position, the pins 516a, 516b are positioned in the central portions of the respective V-shaped apertures 500a, 500b of the sawbar 58. Accordingly, the pins 516a, 516b can exert a clamping force on opposite sides of the saw blade 62. As shown, the pins 516a, 516b are thus wedged against opposite sides of the saw blade 62. When the first collar 520 is in the second position, each of the pins 516a, 516b is positioned within one of the legs 508a, 508b of the respective V-shaped aperture 500a, 500b of the sawbar 58. Accordingly, the pins 516a, 516b in the corresponding aperture 500a, 500b move away from one another such that the saw blade 62 is insertable and removable from the sawbar 58.

When the nut 532 is in the first position, it obstructs the gap 540 and abuts the first collar 520 such that the first collar 520 is not movable from the first position to the second position. The first collar 520 is maintained in the first position by the spring 524. The first collar 520 is axially movable against the bias of the spring 524 to the second position when the nut 532 is in the second position. Because the nut 532 is in the second position and the gap 540 is at least partially unobstructed, the first collar 520 is able to move axially in a direction opposite the arrow 136 toward the second collar 528 to move the pins 516a, 516b away from each other, as noted above.

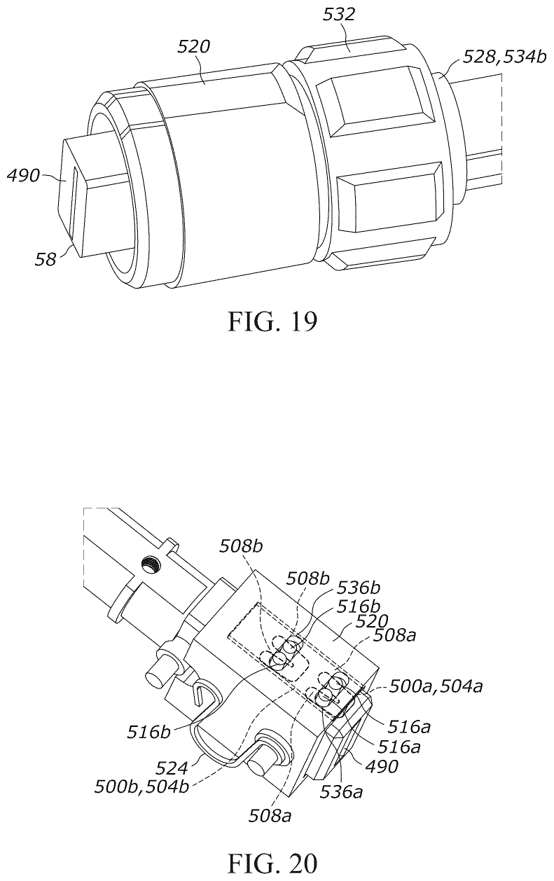

Another blade clamp assembly 568 is shown in FIGS. 21-27 for use with the reciprocating saw 10 of FIG. 1.

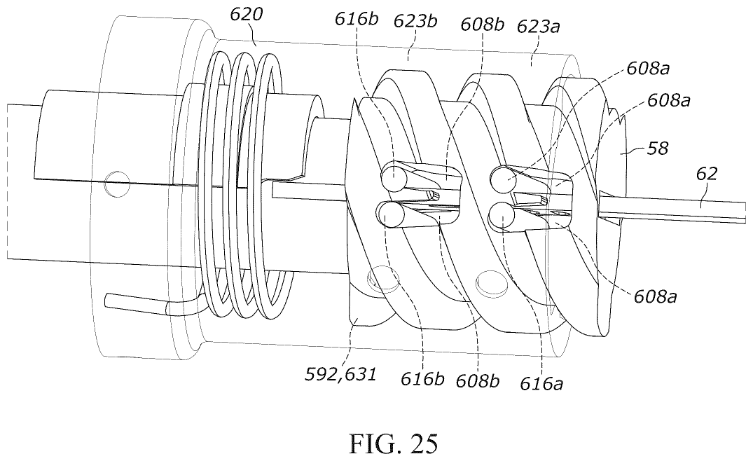

In the embodiment of FIGS. 21-27, the sawbar 58 defines a slot 590 that receives the saw blade 62. The sawbar 58 further includes an engagement interface 592 (FIG. 26) extending along at least a portion of a length thereof. In the illustrated embodiment, the engagement interface 592 is a threaded interface having a plurality of threads. With respect to FIG. 26, the sawbar 58 also includes a first V-shaped aperture 600a and a second V-shaped aperture 600b in each of the top side and the bottom side. The first V-shaped aperture 600a in the top side is aligned with the first V-shaped aperture 600a in the bottom side, and the second V-shaped aperture 600b in the top side is aligned with the second V-shaped aperture 600b in the bottom side. Each of the V-shaped apertures 600a, 600b is in communication with the slot 590. Each of the V-shaped apertures 600a, 600b includes a central portion 604a, 604b and a pair of legs 608a, 608b extending at a non-perpendicular (i.e., oblique) angle from the central portion 604a, 604b. A pair of pins or rollers 616a, 616a extends through the aligned first V-shaped apertures 600a and a pair of pins 616a, 616a extends through the aligned second V-shaped apertures 600b. Each of the pins 616a, 616b has a first end extending from the top side of the sawbar 58 and a second end that extends from the bottom side of the sawbar 58. In other embodiments, the central portion 604a, 604b may be omitted such that the pairs of legs 608a, 608b are not connected to one another.

With respect to FIG. 21, the blade clamp assembly 568 includes the sawbar 58, the pins 516a, 516b, a first collar 620, a spring 624, second collar 628, and a spacer 630. The first collar 620 surrounds and is rotatable relative to the sawbar 58. The second collar 628 is rotatably supported upon the sawbar 58, rotatable with the first collar 620, and spaced apart from the first collar 620. The second collar 628 includes an engagement interface 631. In the illustrated embodiment, the engagement interface 631 includes teeth and grooves that alternate along a circumference of the second collar 628. The spring 624 is coupled to and positioned between the sawbar 58 and the second collar 628. The spring 624 exerts a force on the first collar 620 and the second collar 628 relative to the sawbar 58, as will be discussed below. The spacer 630 is positioned on the sawbar 58 and extends partially along a length thereof. Although the spacer 630 is only shown on one side of the sawbar 58, the spacer 630 is on both sides of the sawbar 58. The spacer 630 is positioned between the sawbar 58 and the second collar 628 and between the sawbar 58 and the spring 624.

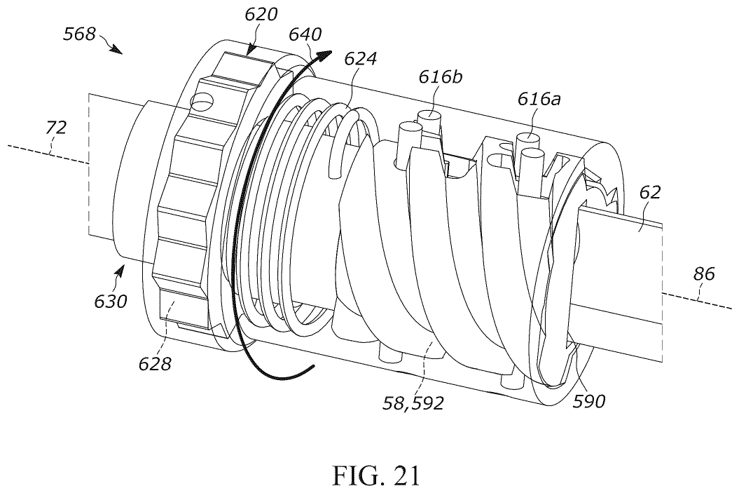

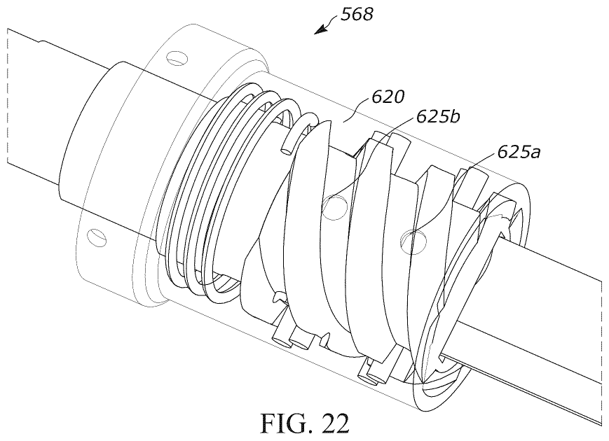

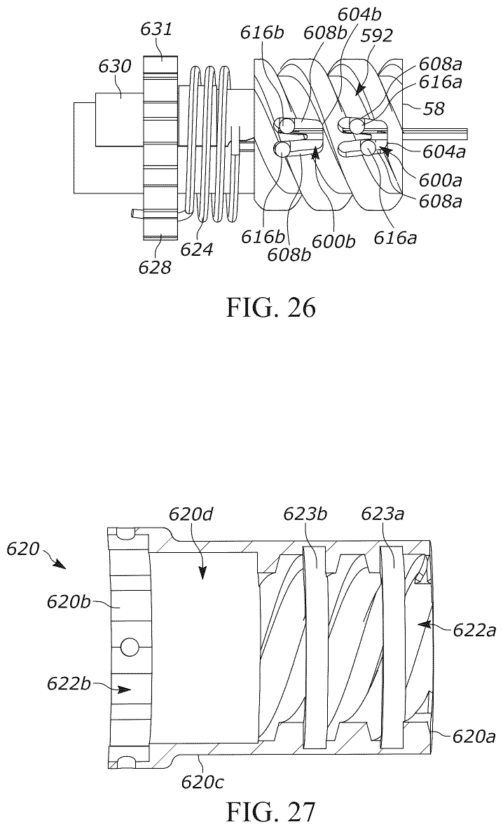

The first collar 620 includes a first end 620a, a second end 620b opposite the first end, an outer wall 620c, and an inner wall 620d. As shown in FIG. 27, the inner wall 620d includes a first engagement interface 622a and a second engagement interface 622b. The first engagement interface 622a extends from the first end 620a towards the second end 620b. In the illustrated embodiment, the first engagement interface 622a is a threaded interface having a plurality of threads. The second engagement interface 622b is positioned at or adjacent to the second end 620b. The second engagement interface 622a includes teeth and grooves that alternate about the circumference of the inner wall 620d. The first collar 620 further includes a first circumferential groove 623a and a second circumferential groove 623b in the inner wall 620d. As shown in FIGS. 22 and 23, the first collar 620 also includes a first through hole 625a and a second through hole 625b extending between the outer wall 620c and the inner wall 620d. The first and second through holes 625a, 625b are aligned with one another along the length of the first collar 620. The first through hole 625a intersects the first circumferential groove 623a and the second through hole 625b intersects the second circumferential groove 623b.

The first collar 620 surrounds and is rotatable relative to the sawbar 58. More specifically, the first collar 620 surrounds and is rotatable relative to the engagement interface 592 of the sawbar 58. The engagement interface 622a of the collar matingly engages the engagement interface 592 of sawbar 58. Accordingly, the first collar 620 is rotatable relative to the sawbar 58 via the complementary engagement interfaces 592, 622a. As shown, the first collar 620 is threadable relative to the sawbar 58 via the complementary threaded interfaces 592, 622a. Each of the first end and the second end of the pins 616a, 616b is received in and movable relative to circumferential grooves 623a, 623b in the first collar 620. The through holes 625a, 625b enable the pins 616a, 616b to be inserted into the blade clamp assembly 568. As shown in FIG. 23, the pins 616a, 616b may be dropped into the respective through hole 625a, 625b as the first collar 620 is rotated or threaded past the respective central portions 604a, 604b of the V-shaped apertures 600a, 600b. The second collar 628 has an inner diameter that is greater than the outer diameter of the sawbar 58. The larger inner diameter of the second collar 628 enables the second collar 628 to be assembled to the sawbar 58 over ribs 59 (not shown in FIGS. 21-27 but shown in FIG. 18). The spacer 630 is positioned between the sawbar 58 and the second collar 628 to take up the space between the outer diameter of the sawbar 58 and the inner diameter of the second collar 628. The second collar 628 is spaced apart from the first collar 620. The spring 624 extends between the sawbar 58 and the second collar 628. Due to the engagement between the engagement interface 622b of the first collar 620 and the engagement interface 631 of the second collar 628, the second collar 628 is rotatable with the first collar 620 relative to the sawbar 58. During assembly, prior to the first collar 620 being coupled to the second collar 628, the second collar 628 is rotatable along the length of the sawbar 58 to adjust the bias (e.g., tension) of the spring 624 relative to the sawbar 58.

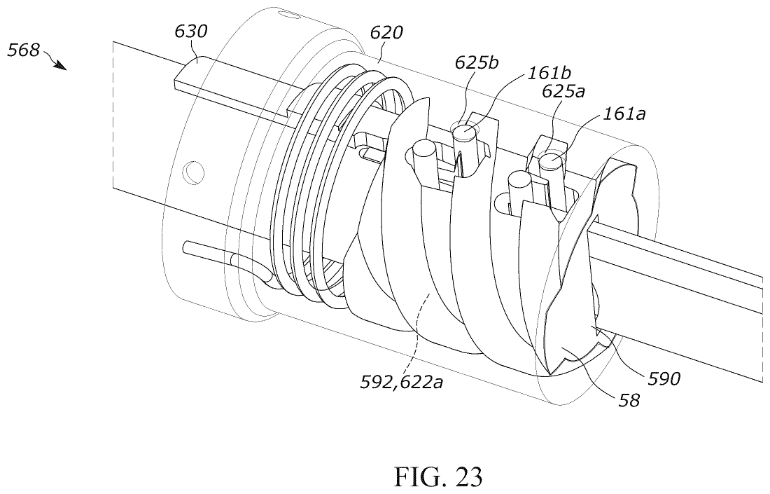

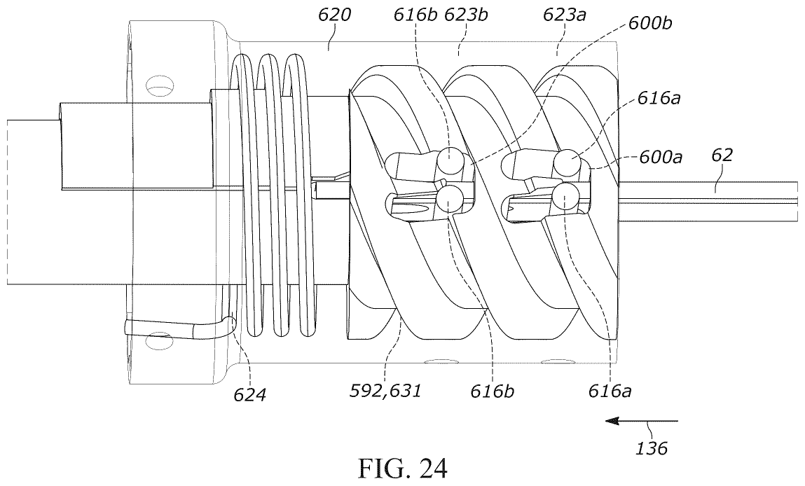

The first collar 620 is movable (e.g., rotatable, threadedable) between a first position (FIG. 24) and a second position (FIG. 25). When the first collar 620 is in the first position, the pins 616a, 616b are positioned in the central portions of the respective V-shaped apertures 600a, 600b of the sawbar 58. Accordingly, the pins 616a, 616b can exert a clamping force on opposite sides of the saw blade 62. The spring 624 biases and maintains the first collar 620 into the first position. When the first collar 620 is in the second position, each of the pins 616a, 616b is positioned within one of the legs 608a, 608b of the respective V-shaped aperture 600a, 600b of the sawbar 58. Accordingly, as the first collar 620 rotates from the first position to the second position, the first collar 620 is also axially movable parallel to the reciprocating axis 86 in the direction of arrow 136. As the first collar 620 rotates, the pins 616a, 616b are circumferentially guided within the respective circumferential groove 623a, 623b such that the pins 616a, 616b in the corresponding aperture 600a, 600b move rearwardly and away from one another into the respective leg 608a, 608b. With the pins 616a, 616b positioned within the respective leg 608a, 608b, the saw blade 62 is insertable and removable from the sawbar 58. The first collar 620 is rotatable relative to the sawbar 58 to overcome the bias of the spring 624 to achieve the second position. The first collar 620 is rotatable in the direction of arrow 640 (FIG. 21) to overcome the bias of the spring 624 to move the pins 616a, 616b away from each other, as noted above. When the first collar 620 is released, due to the bias of the spring 624, it is rotatable in a direction opposite arrow 640 to move from the second position back to the first position.

Although the invention has been described in detail with reference to certain preferred embodiments, variations and modifications exist within the scope and spirit of one or more independent aspects of the invention as described.

Various features of the invention are set forth in the following claims.

1. A blade clamp assembly comprising:
a sawbar configured to reciprocate along a reciprocating axis;
a saw blade configured to reciprocate with the sawbar along the reciprocating axis;
a cover coupled to the sawbar to at least partially define, in tandem with the sawbar, a blade slot in which the saw blade is receivable, the cover including a detent slot in facing relationship with the sawbar;
a detent positioned and movable in the detent slot, the detent configured to selectively engage the saw blade when positioned within the blade slot; and
an actuator at least partially positioned between the cover and the sawbar, the actuator including a tapered surface engageable with the detent to move the detent within the detent slot;
wherein the actuator is movable in a direction perpendicular to the reciprocating axis between a first position, in which the tapered surface and a surface of the detent slot wedge the detent against the saw blade to impart a clamping force to the saw blade and secure the saw blade within the blade slot, and a second position, in which the tapered surface permits the detent to disengage the saw blade and release the clamping force.

2. The blade clamp assembly of claim 1, wherein the detent is horizontally movable within the detent slot as the actuator moves between the first position and the second position.

3. The blade clamp assembly of claim 1, wherein the detent slot is positioned along a detent slot axis that is oriented at a non-parallel angle relative to the reciprocating axis.

4. The blade clamp assembly of claim 3, wherein the detent is horizontally movable along the detent slot axis as the actuator moves between the first position and the second position.

5. The blade clamp assembly of claim 1, wherein the actuator includes a Z-shaped aperture that movably receives the detent, and wherein the tapered surface is defined by the Z-shaped aperture.

6. The blade clamp assembly of claim 1, wherein the actuator is biased into the first position by a spring.

7. The blade clamp assembly of claim 6, wherein the spring is positioned between the sawbar and the cover.

8. The blade clamp assembly of claim 1, wherein the detent is a ball.

9. A blade clamp assembly comprising:
a sawbar configured to reciprocate along a reciprocating axis;
a saw blade configured to reciprocate with the sawbar along the reciprocating axis;
a cover coupled to the sawbar to at least partially define, in tandem with the sawbar, a blade slot in which the saw blade is receivable, the cover including a detent slot in facing relationship with the sawbar, the detent slot positioned along a detent slot axis that is oriented at a non-parallel angle relative to the reciprocating axis;
a detent positioned and movable in the detent slot, the detent configured to selectively engage the saw blade when positioned within the blade slot; and
an actuator at least partially positioned between the cover and the sawbar, the actuator including a tapered surface engageable with the detent to move the detent within the detent slot;
wherein the actuator is movable in a direction perpendicular to the reciprocating axis between a first position, in which the detent is wedged against the saw blade to impart a clamping force to the saw blade to secure the saw blade within the blade slot, and a second position, in which the detent is positioned to disengage the saw blade and release the clamping force, and
wherein moving the actuator between the first position and the second position moves the detent within the detent slot along the detent slot axis.

10. The blade clamp assembly of claim 9, wherein the detent is horizontally movable within the detent slot along the detent slot axis as the actuator moves between the first position and the second position.

11. The blade clamp assembly of claim 9, wherein the actuator includes a Z-shaped aperture that movably receives the detent, and wherein the tapered surface is defined by the Z-shaped aperture.

12. The blade clamp assembly of claim 9, wherein the actuator is biased into the first position by a spring.

13. The blade clamp assembly of claim 12, wherein the spring is positioned between the sawbar and the cover.

14. A blade clamp assembly comprising:
a sawbar configured to reciprocate along a reciprocating axis;
a saw blade configured to reciprocate with the sawbar along the reciprocating axis;
a cover coupled to the sawbar to at least partially define, in tandem with the sawbar, a blade slot in which the saw blade is receivable, the cover including a detent slot in facing relationship with the sawbar, the detent slot having a first end and a second end opposite the first end, the first end being positioned closer to the blade slot than the second end;
a detent positioned and movable in the detent slot, the detent configured to selectively engage the saw blade when positioned within the blade slot; and
an actuator at least partially positioned between the cover and the sawbar, the actuator including a tapered surface engageable with the detent to move the detent within the detent slot;
wherein the actuator is movable in a direction perpendicular to the reciprocating axis between a first position, in which the detent is positioned adjacent to the first end of the detent slot and is wedged against the saw blade to impart a clamping force to the saw blade to secure the saw blade within the blade slot, and a second position, in which the detent is spaced apart from the first end of the detent slot and positioned to disengage the saw blade and release the clamping force.

15. The blade clamp assembly of claim 14, wherein the actuator includes a Z-shaped aperture that defines the tapered surface and that overlaps the detent slot, and wherein the detent is received within the Z-shaped aperture such that the detent is movable within the Z-shaped aperture as the actuator moves between the first position and the second position.

16. The blade clamp assembly of claim 14, wherein the detent is horizontally movable within the detent slot as the actuator moves between the first position and the second position.

17. The blade clamp assembly of claim 14, wherein the actuator is biased into the first position by a spring.

18. The blade clamp assembly of claim 17, wherein the spring is positioned between the sawbar and the cover.

19. The blade clamp assembly of claim 14, wherein the detent slot is positioned along a detent slot axis that is oriented at a non-parallel angle relative to the reciprocating axis.

20. The blade clamp assembly of claim 19, wherein the detent is horizontally movable along the detent slot axis as the actuator moves between the first position and the second position.

21. (canceled)

22. (canceled)
